(19) United States
(12) Patent Application Publication
(10) Pub. No.: US 2021/0251242 A1
(43) Pub. Date: Aug. 19, 2021

(54) RODENT REPELLING SPRAY POLYURETHANE FOAM SYSTEM

(71) Applicant: Jan Prins, Foremost (CA)

(72) Inventor: Jan Prins, Foremost (CA)

(21) Appl. No.: 16/789,477

(22) Filed: Feb. 13, 2020

(51) Int. Cl. A01N 65/22; A01N 25/16; A01N 65/24

(52) U.S. Cl. CPC A01N 65/22; A01N 65/24; A01N 25/16

(57) ABSTRACT

A two-component spray polyurethane foam (SPF) has rodent repelling properties. A rodent repelling spray polyurethane foam includes the reaction product of an A-side component comprising isocyanate and a B-side component comprising between about 2.5 and about 3.5 weight percentage of essential oil of peppermint, essential oil of spearmint, or a combination of both. The volume ratio of the A-side component to the B-side component is between about 1:1 to about 1.5:1.

### FIELD OF THE INVENTION

The present disclosure relates spray polyurethane foam having rodent repellent characteristics.

### BACKGROUND OF THE INVENTION

Spray polyurethane foam (SPF) has been used for many years as insulation and an air sealing product. However, rodents cause substantial damage to the SPF by chewing and scratching through it. Often rodents chew and scratch at the SPF to create an entry point through the SPF into a building or vessel, for example. The damage caused by rodents to the SPF can be difficult and expensive to repair.

To prevent rodent damage and incursion, some applications allow for using traps or poisons are to kill rodents. In addition to creating dead animal disposal problems, traps and poisons also pose dangers to humans, pets, and other animals, and have environmental hazard concerns. In other applications, using traps or poisons are just not possible because of either environmental or structural restrictions.

Accordingly, there is need and a desire for SPF that has rodent repelling ability to deter rodents from scratching and chewing at the SPF.

### SUMMARY OF THE INVENTION

The disclosure that follows describes a spray polyurethane foam (SPF) having rodent repelling properties that operate to deter rodents from scratching at and chewing through the SPF. The rodent repelling properties of the SPF is provided by natural, non-hazardous components that are not harmful to humans, pets, or animals, and do not cause environmental hazard concerns.

In one aspect, rodent repelling spray polyurethane foam includes a reaction product of an A-side component comprising isocyanate; a B-side component comprising between about 2.5 and about 3.5 weight percentage of essential oil of peppermint, essential oil of spearmint, or a combination of both; and wherein the volume ratio of the A-side component to the B-side component is between about 1:1 to about 2.0:1.

In another aspect, a rodent repelling spray polyurethane foam includes between about 1.0 and 1.5 weight percentage of essential oil of peppermint, essential oil of spearmint, or a combination of both.

In yet another aspect, a method of applying a rodent repelling spray polyurethane foam includes the steps of: providing an A-side component comprising isocyanate and a B-side component comprising between about 2.5 and about 3.5 weight percentage of essential oil of peppermint, essential oil of spearmint, or a combination of both; preparing a surface on which to apply the foam; reacting the A-side component and the B-side components; and applying the reacting components to a surface.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a schematic diagram a two-component spray polyurethane foam system in accordance with the present invention; and

FIG. 2 is a section taken along line 2-2 of FIG. 1.

### DETAILED DESCRIPTION OF THE INVENTION

Spray Polyurethane foams (SPF) and their methods of manufacture are well known. Typically, spray polyurethane foams are formed from two separate components, commonly referred to as an A-side and a B-side, that react when they contact each other. The first component, or the A-side, may contain an isocyanate such as a di- or poly-isocyanate that has a high percent of NCO (nitrogen, carbon and oxygen) functional groups on the molecule. The second component, or B-side, may contain nucleophilic reagents such as polyols that include two or more hydroxyl groups, silicone-based surfactants, blowing agents, catalysts, and/or other auxiliary agents.

The two components are typically delivered through separate lines into a spray gun such as an impingement-type spray gun. The first and second components are pumped through small orifices at high pressure to form separate streams of the individual components. The streams of the first and second components intersect and mix with each other within the gun and begin to react. The heat of the reaction causes the temperature of the reactants in the first and second components to increase. This rise in temperature causes the blowing agent located in the second component (the B-side) to vaporize and form a foam mixture. As the mixture leaves the gun, the mixture contacts a surface, sticks to it, and continues to react until the isocyanate groups have completely reacted.

I have found the addition of essential oil of mint from the genus Mentha and, particularly, essential oil of peppermint (M. balsamea), essential oil of spearmint (M. spicata), or a combination of both to the B-side component results in the SPF having rodent repellant properties. And the addition of the essential oil to the B-side component does not adversely affect the reaction between the A-side and B-side components nor adversely affect the resulting SPF properties.

Upon experimentation, I have found that an effective amount of essential oil of peppermint, essential oil of spearmint, or a combination of both is between about 2.5 and about 3.5 weight percentage of the B-side component. For example, a 250-kg drum of a B-side component would have about 7.5-kg of essential oil of peppermint, essential oil of spearmint, or a combination of both. The essential oil is in 100 percent pure form and is not cut by any additional oils or carriers.

This effective amount is considering the resulting SPF has volume ratio of the A-side component to the B-side component is between about 1:1 to about 1:1.5. With this volume ratio, the resulting SPF has between about 1.0 and 1.5 weight percentage of essential oil of peppermint, essential oil of spearmint, or a combination of both.

Through my experimentation, I found that increasing the weight percentage of the essential oil does not increase effectiveness of the rodent repellant properties of the SPF. Rather, it only increases the cost of the SPF without any resulting benefits. Therefore, I have found an effective amount of essential oil of peppermint, essential oil of spearmint, or a combination of both that is between about 2.5 and about 3.5 weight percentage of the B-side component is a critical amount that balances cost with effectiveness with a volume ratio of the A-side component to the B-side component between about 1:1 to about 1:1.5. This experimentation was conducted using Boreal Nature Type 2 spray applied polyurethane foam made by Genyk corporation.

In another embodiments, I have found that adding cinnamon oil in addition to essential oil of mint from the genus Mentha is also effective at repelling and deterring rodents from chewing through the polyurethane foam. In such embodiments, the cinnamon oil is added to the B-side component at a ratio of about 1:1 with the essential oil of mint. For example, in an embodiment, a combination of cinnamon oil and essential oil of mint from the genus Mentha is added to the B-side component such that the cinnamon oil and the essential oil of mint combined is between about 2.5 and about 3.5 weight percentage of the B-side component and the ratio between the cinnamon oil and he essential oil of mint is about 1:1. In a specific embodiment, the essential oil of mint is essential oil of peppermint, essential oil of spearmint, or a combination of both.

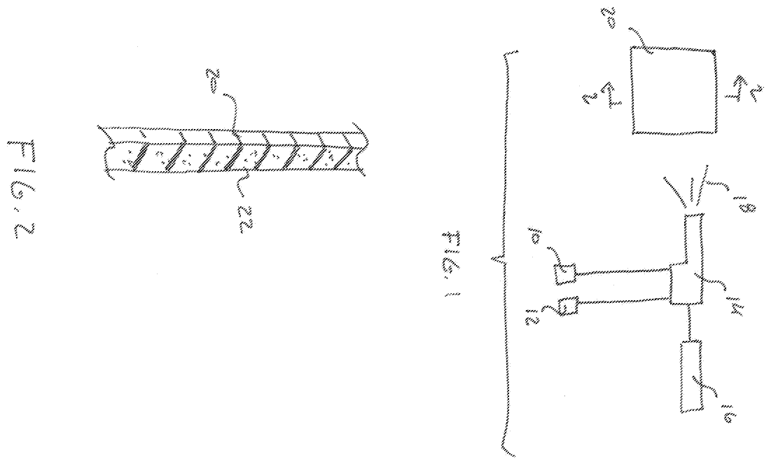

A two-component polyurethane foam system is shown schematically in FIG. 1 wherein a canister 10 contains the A-side and a canister 12 contains the B-side, the canisters communicating with a mixing or proportioning head 14 under pressure from a propellant 16. The A-side and B-side are mixed under the propellant's pressure and sprayed, as shown at 18, onto an application surface 20. As soon as the blend hits the surface 20 foaming will start, and a desired foam thickness is achieved. The resulting SPF having rodent repellant proprieties provide by the essential oil. FIG. 2 is a cross-section of the SPF 22 on the surface 20.

While the invention has been particularly shown and described with respect to the illustrated embodiments thereof, it will be understood by those skilled in the art that the foregoing and other changes in form and details may be made therein without departing from the spirit and scope of the invention.

1. A rodent repelling spray polyurethane foam comprising the reaction product of:
an A-side component comprising isocyanate and a B-side component comprising between about 2.5 and about 3.5 weight percentage of essential oil of mint from the genus Mentha; and
wherein the volume ratio of the A-side component to the B-side component is between about 1:1 to about 1.5:1.

2. The rodent repelling spray polyurethane foam of claim 1 wherein the essential oil of mint from the genus Mentha is essential oil of peppermint, essential oil of spearmint, or a combination of both.

3. A rodent repelling spray polyurethane foam comprising between about 1.0 and 1.5 weight percentage of essential oil of mint from the genus Mentha.

4. The rodent repelling spray polyurethane foam of claim 3 wherein the essential oil of mint from the genus Mentha is essential oil of peppermint, essential oil of spearmint, or a combination of both.

5. A rodent repelling spray polyurethane foam comprising the reaction product of:
an A-side component comprising isocyanate and a B-side component comprising between about 2.5 and about 3.5 weight percentage of a combination of essential oil of mint from the genus Mentha and cinnamon oil at about a 1:1 ratio between the essential oil of mint and the cinnamon oil; and
wherein the volume ratio of the A-side component to the B-side component is between about 1:1 to about 1.5:1.

6. The rodent repelling spray polyurethane foam of claim 5 wherein the essential oil of mint from the genus Mentha is essential oil of peppermint, essential oil of spearmint, or a combination of both.
